(19) United States
(12) Patent Application Publication
(10) Pub. No.: US 2016/0292768 A1
(43) Pub. Date: Oct. 6, 2016

(54) VEHICLE RATINGS VIA MEASURED DRIVER BEHAVIOR

(71) Applicant: Bradford H. Needham, (US)

(72) Inventor: Bradford H. Needham, (US)

(21) Appl. No.: 14/368,438

(22) PCT Filed: Dec. 23, 2013
(86) PCT No.: PCT/US2013/077409

§ 371 Date: Jun. 24, 2014

(51) Int. Cl. G06Q 30/06; G06F 17/30; G06Q 30/02

(52) U.S. Cl. CPC G06Q 30/0631; G06Q 30/0278; G06F 17/30864

(57) ABSTRACT

Various systems and methods for obtaining and providing vehicle ratings via measured driver behavior are described herein. A system includes a receiving module to receive vehicle operation data for a vehicle, a determination module to use the vehicle operation data in determining data describing how the vehicle was used, a search module to search a vehicle database to identify vehicles similar to the vehicle. an aggregation module to aggregate the data describing how the vehicle was used with data describing how vehicles similar to the vehicle were used, to produce aggregated data, and a calculation module to calculate a result based on the aggregated data.

### TECHNICAL FIELD

Embodiments described herein generally relate to vehicle evaluations and in particular, to vehicle ratings via measured driver behavior.

### BACKGROUND

Purchasing a vehicle is an expensive endeavor in terms of both cost and time. Potential buyers spend many hours researching vehicle specifications, test drives, and other feedback to identify potential purchases. When a purchase decision is made, many thousands of dollars may be spent to finance, equip, and maintain a vehicle.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is a schematic drawing illustrating a system to create vehicle ratings, according to an embodiment;

FIG. 2 is a data flow diagram illustrating a process and system to recommend vehicles to user, according to an embodiment;

FIG. 3 is a flowchart illustrating a method for calculating vehicle ratings via measured driver behavior, according to an embodiment;

FIG. 4 is a flowchart illustrating a method for providing vehicle ratings, according to an embodiment; and

FIG. 5 is a block diagram illustrating an example machine upon which any one or more of the techniques (e.g., methodologies) discussed herein may perform, according to an example embodiment.

### DETAILED DESCRIPTION

Current methods of recommending, ranking, or rating cars to potential car buyers and renters require explicit input from either expert reviewers or from users of the car. There are several problems with this approach. First, expert reviews are costly to create, and reflect the opinions of a small set of people. Second, the number of car owners who take the time to write a useful review is small. In addition, reviews are sometimes written by people who have no experience with the car, who may wish to unfairly improve or lower shoppers' impressions (“reputation management”). Further deficiencies with these types of reviews are that manual rating systems generally cover a very small number of dimensions. For example, a rating may indicate that a particular vehicle is good or bad for some general facet, rather than a more in-depth rating, such as the “suitability for a person who has three small children.”

In both the expert reviews and the user reviews, subjectivity is involved. Self-reporting is notoriously inaccurate compared to objective measurements. For example, a particular car may be thought of by its owners as a sporty car even though its objective performance is rather poor. Existing car rating systems do not answer the basic question of “how do people actually use this car?” For example, a person looking for a sporty car must rely on the car being advertised as a “sporty car” and must rely on written reviews of the car. It is very difficult for the shopper to get a clear idea of whether people actually find a supposedly sporty car capable of a sporty drive.

Similarly, a person looking for a good car for transporting two adults and three young kids may find it difficult to discover whether a particular car is often used to transport that type of group of people. At best, other people may rate the car as a good “family car,” but the shopper may find it hard to relate those reviews to the actual usage of the car.

Thus, what is needed is a system to capture objective measurements and use these measurements to create vehicle ratings. The objective measurements may be obtained using on-board vehicle sensors and systems, such as on-board diagnostics systems (e.g., OBD II). The sensed data may be sent to a system to gather data from one or more vehicles and derive trends and statistics to determine how a vehicle is used and how the vehicle performs when it is used in various ways. This data may then be presented to potential vehicle buyers to assist in research and purchase decisions.

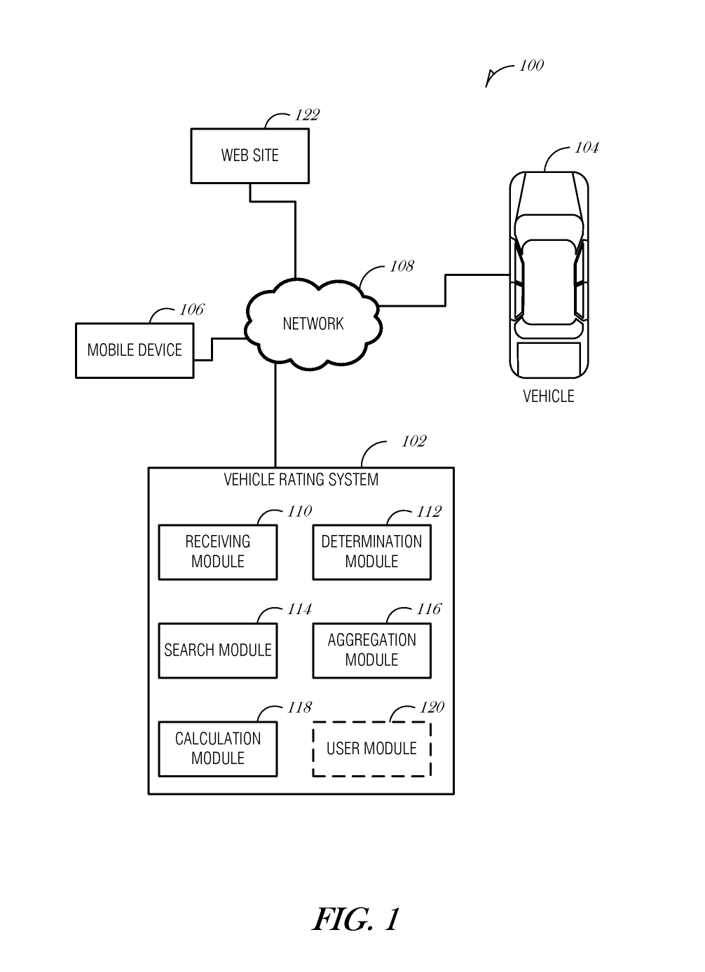

FIG. 1 is a schematic drawing illustrating a system 100 to create vehicle ratings, according to an embodiment. FIG. 1 includes a vehicle rating system 102, a vehicle 104, and a mobile device 106, communicatively coupled via a network 108.

The vehicle 104 may be of any type of vehicle, such as a commercial vehicle, consumer vehicle, or recreation vehicle. The vehicle 104 includes an on-board diagnostics system to record aspects of vehicle operation and other aspects of the vehicle's performance, maintenance, or status. The vehicle 104 may also include various other sensors, such as driver identification sensors (e.g., a seat sensor, an eye tracking and identification sensor, a fingerprint scanner, a voice recognition module, or the like), occupant sensors, or various environmental sensors to detect wind velocity, outdoor temperature, barometer pressure, rain/moisture, or the like.

The mobile device 106 may be a device such as a smartphone, cellular telephone, mobile phone, laptop computer, tablet computer, or other portable networked device. In general, the mobile device 106 is small and light enough to be considered portable and includes a mechanism to connect to a network, either over a persistent or intermittent connection.

The network 108 may include local-area networks (LAN), wide-area networks (WAN), wireless networks (e.g., 802.11 or cellular network), the Public Switched Telephone Network (PSTN) network, ad hoc networks, personal area networks (e.g., Bluetooth) or other combinations or permutations of network protocols and network types. The network 108 may include a single local area network (LAN) or wide-area network (WAN), or combinations of LANs or WANs, such as the Internet. The various devices (e.g., mobile device 106 or vehicle 104) coupled to the network 108 may be coupled to the network 108 via one or more wired or wireless connections.

In operation, the vehicle 104 is driven for a period of time, during which the on-board diagnostics system records various vehicle operation data. Vehicle operation data may include, but is not limited to average fuel consumption (e.g., miles per gallon or kilometers per liter), acceleration/deceleration patterns, turning patterns, average vehicle speed, amount of fuel consumed, emissions, outdoor weather, road conditions, occupant information, vehicle feature use (e.g., anti-lock braking, air bag use, intermittent wipers, dynamic vehicle handling, etc.), and the like. Additional examples of vehicle operation data include performance data related to the driving of the vehicle. For example, speed data, g-load data, mileage data, average acceleration, average deceleration, and the like. Vehicle performance data may also include, in further examples, engine performance data, such as, oil temperature, fluid levels, cylinder temperature, spark plug voltage, fuel-air mixture, fuel flow, air pressure, boost pressure (if engine is turbocharged, or supercharged), emissions gas readings, and the like. Collectively, these may also be called vehicle performance metrics. Though impacted by the driving of the vehicle, aggressive driving, or risky driving, per se, would not be immediately apparent by looking at these data sources without regard to others. Vehicle performance metrics may be characterized as that data that is collected by the vehicle itself during normal monitoring of its own performance. Operational data with respect to driver behavior may be collected by bolt on, or after market, installed units. Data may also be directly read from engine monitoring systems installed by the manufacturer of the vehicle by the mobile device 106 or the vehicle rating system 102.

In an embodiment, the vehicle rating system 102 includes a receiving module 110, a determination module 112, a search module 114, an aggregation module 116, and a calculation module 118. The vehicle rating system 102 operates as a system to calculate vehicle ratings via measured driver behavior. The receiving module 110 is operable to receive vehicle operation data for a vehicle 104. In various embodiments, the vehicle operation data comprises a vehicle performance metric or an environmental metric. The vehicle performance metric may comprise a vehicle speed, fuel efficiency, an acceleration, or a deceleration. The environmental metric may comprise a number of occupants in the vehicle, a condition of the road that the vehicle 104 has travelled over, an outside temperature, a weather metric that the vehicle 104 was operated in, or a route that the vehicle 104 was driven. The vehicle operation data may be received directly from the vehicle 104. In an alternative embodiment, to receive vehicle operation data for the vehicle, the receiving module 110 is to receive the vehicle operation data from a user device (e.g., mobile device 102), which obtained the vehicle operation data when communicatively connected to the vehicle 104. The vehicle 104 may be any type of vehicle, including but not limited to a car, a truck, a motorcycle, a boat, a bicycle, or a recreational vehicle.

The determination module 112 is operable to use the vehicle operation data in determining data describing how the vehicle 104 was used. In an embodiment, to determine data describing how the vehicle was used, the determination module 112 is to evaluate the vehicle operation data to determine an acceleration/deceleration pattern and rate the acceleration/deceleration pattern on a conservative-sportiness driving continuum. In an embodiment, to determine data describing how the vehicle was used, the determination module 112 is to evaluate the vehicle operation data to determine an turning pattern and rate the turning pattern on a conservative-sportiness driving continuum. Turning patterns refer to the gyrometry involved describing how quickly the vehicle makes a turn. A more aggressive turning pattern may indicate harder, sharper turns, which may indicate a more athletic, sporty vehicle. The conservative-sportiness driving continuum may be represented as a scale, such as from 1 to 100 or from one star to five stars, with the higher value indicating a more sporty driving pattern. With such information, a user may be able to determine that the vehicle 104 is more or less likely to be able or desirable to drive in a sporty manner.

In an embodiment, to determine data describing how the vehicle was used, the determination module 112 is to evaluate the vehicle operation data to determine a fuel efficiency pattern and rate the fuel efficiency pattern in view of a generally accepted estimated fuel efficiency. The generally accepted estimated fuel efficiency may be designated by a local, municipal, state, or federal standards group. For example, an EPA (Environmental Protection Agency) estimated MPG (miles per gallon) may be assigned to the vehicle 104. Using actual fuel efficiency values as measured over one or more tanks of fuel, the determination module 112 may determine that the estimated MPG is off by some value, which may be used by a shopper to more accurately estimate cost and value of a vehicle. Further, the fuel efficiency pattern rating may be correlated to driving style, to give a car shopper a personalized idea of what mileage they may expect from a given car. For electric vehicles, charging frequency and duration statistics may be similarly compared.

In an embodiment, to determine data describing how the vehicle was used, the determination module 112 is to evaluate the vehicle operation data to determine an occupant pattern and rate the occupant pattern on a family car use continuum. A vehicle 104 that is typically occupied by only one or two people, rather than four or five people, may be indicative that the vehicle 104 is not suitable or comfortable for use by more than two people (e.g., not a family-oriented vehicle). Seat sensors may be used to determine the number of passengers and their approximate weight, which may identify vehicles that are frequently used as family cars (e.g., with two or more adult-sized occupants and one or more child-sized occupants).

In a similar vein, the occupant pattern may be used to determine whether the vehicle is operated by one person or several people. Many car models identify the driver by, for example, the key they use (e.g., by key fob RFID). Other means of identification have been shown feasible by others (e.g., face recognition; weight distribution in seat; settings of seat position, etc.) This information over time may suggest whether multiple people share the car (husband, wife, and driving child) vs. it being mainly one person's car. Thus, in an embodiment, to determine data describing how the vehicle was used, the determination module 112 is to evaluate the vehicle operation data to determine an occupant pattern and rate the occupant pattern on a shared vehicle continuum. The shared vehicle continuum may be represented as a scale, such as from 1 to 100 or from one star to five stars, with the higher value indicating that the vehicle 104 is shared more often than not.

In an embodiment, to determine data describing how the vehicle was used, the determination module 112 is to evaluate the vehicle operation data to determine a usage route pattern; and rate the usage route pattern on a commuter-vacation use continuum. The route or the distance the vehicle is driven in a given timeframe (e.g., per month) may be indicative that the vehicle 104 is used as a daily driver (e.g., commuter vehicle) or a as a special use vehicle (e.g., weekend vehicle, seasonal, or vacation vehicle). As with the other continuums discussed above, the commuter-vacation use continuum may be represented as a scale, such as from 1 to 100 or from one star to five stars, with the higher value indicating that the vehicle 104 is used as a vacation or special use vehicle more often than not.

In an embodiment, to determine data describing how the vehicle was used, the determination module 112 is to evaluate the vehicle operation data to determine a usage pattern for one of a weather or road condition that describes a driving situation and rate the usage pattern for the driving situation. The weather may be rain, snow, sleet, overcast, hail, sunny, dry, or the like. Similarly, the road condition may be considered dry, slick, icy, wet, rough, paved, unpaved, dirt, gravel, or the like. The usage pattern in various weather or road conditions provides insight into the vehicle's ability. There may be several usage patterns, one for each type of driving situation. Thus, a vehicle 104 may be rated on its performance in snow with one rating and its performance in rain with another rating. The ratings may be scaled to a numerical scale (e.g., 1-100) or another enumerated value (e.g., one to five stars).

The search module 114 is operable to search a vehicle database to identify vehicles similar to the vehicle. The vehicle database may be located at the vehicle rating system 102 or remote from the vehicle rating system 102. Various criteria may be used to search the vehicle database.

In an embodiment, to search the vehicle database to identify vehicles similar to the vehicle, the search module 114 is to identify at least one of a make, a model, or a year of the vehicle and search the vehicle database to identify vehicles similar to the vehicle based on at least one of the make, the model, or the year of the vehicle.

In an embodiment, to search the vehicle database to identify vehicles similar to the vehicle, the search module 114 is to identify how the vehicle was used and search the vehicle database to identify vehicles similar to the vehicle based on how the vehicle was used. For example, an acceleration/deceleration pattern derived from data obtained from an on-board system may indicate that the vehicle 104 was driven in a conservative manner. As such, the search module 114 may search for vehicles in the vehicle database that have the same or similar score indicating a conservative driving type.

The aggregation module 116 is operable to aggregate the data describing how the vehicle was used with data describing how vehicles similar to the vehicle were used, to produce aggregated data.

The calculation module 118 is operable to calculate a result based on the aggregated data. The result may indicate various statistical data, usage data, or other rankings or ratings of a vehicle's use or ability.

In an embodiment, to calculate the result based on the aggregated data, the calculation module 118 is to identify a typical use of the vehicle based on the aggregated data and represent the result as an indication of the typical use. In an embodiment, the indication of the typical use comprises a percentage indicating the amount of time the vehicle was used in accordance with the typical use. For example, the indication of use may be “the vehicle was driven in a sporty manner 70% of the time the vehicle was in operation.” In an embodiment, the indication of the typical use comprises a percentage indicating the amount of distance the vehicle was used in accordance with the typical use. For example, the indication of use may be “the vehicle was driven 3,000 miles in a sporty manner.” In an embodiment, the amount of distance comprises one of a miles or a kilometers.

The vehicle rating system may optionally include a user module 120. The user module 120 may receive from a user, an identification of a driver and determine characteristics of the driver. The user may interact with a web site 122 to input data and receive recommended vehicles. The web site 122 may be hosted by the vehicle rating system 102 or separate from it. The user may access the web site 122 using various mechanisms, such as by way of a desktop computer, a kiosk, or from a mobile device 106.

Characteristics of the driver may be data indicating that the driver has a family, or likes to drive in a sporty manner, or lives in an area of the country that has snowy winters and dry summers. With the driver information, the user module 120 may match the driver with a recommended vehicle by comparing the characteristics of the driver with the result based on the aggregated data from the vehicle database. The user module 120 may then provide the recommended vehicle to the user. It is understood that more than one vehicle may be presented to the user and that more than one vehicle may be marked as being recommended. For example, a user who drives conservatively and lives in a snowy climate may be presented with three recommended vehicles, one in a sports-utility class, one in a sedan class, and one in a compact vehicle class. If the user were to indicate that she has a family of five, then the vehicle rating system 102 may omit the compact vehicle class suggestion.

The user module 120 may receive from a user, an intended use of vehicle and search the vehicle database to identify a recommended vehicle that corresponds with the intended use of the vehicle. After obtaining the search results, the user module 120 may provide the recommended vehicle to the user (e.g., via the web site 122).

In an embodiment, the user module 120 is to provide a statistical breakdown describing how the recommended vehicle was used. The statistical breakdown may indicate the number of hours used or the percentage of time the vehicle was used for a particular use (e.g., as a family vehicle or as a shared vehicle, etc.) or in a particular manner (e.g., driven sportily or conservatively).

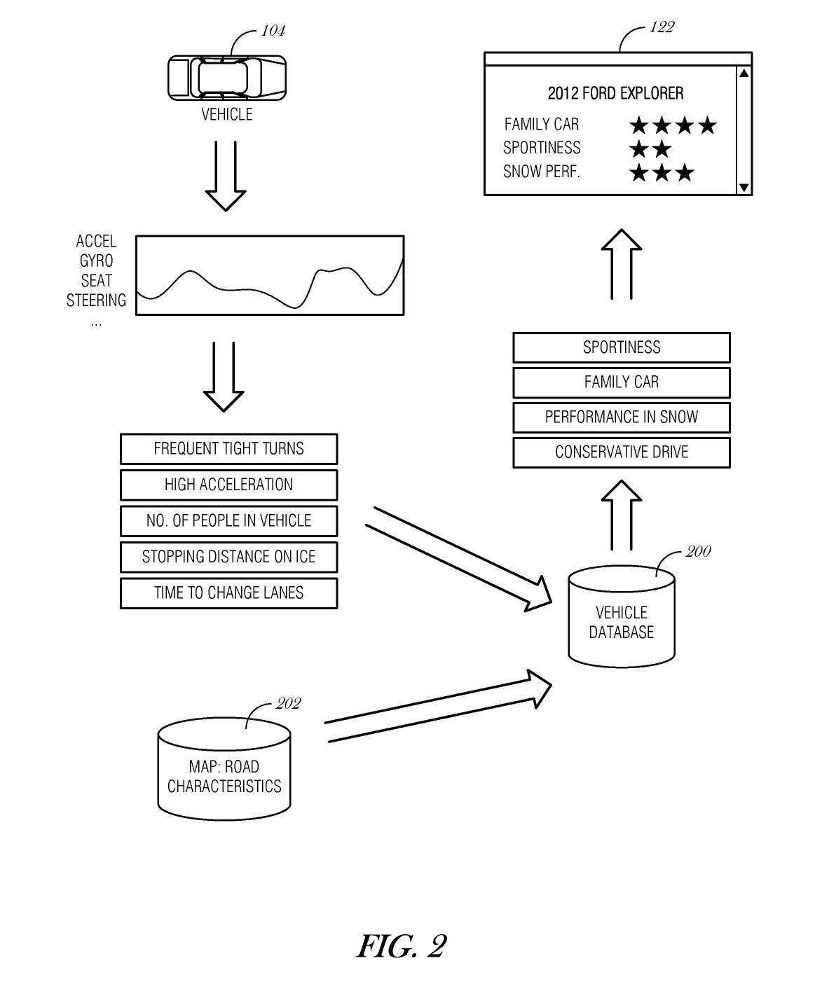

FIG. 2 is a data flow diagram illustrating a process and system to recommend vehicles to user, according to an embodiment. Data is collected from operation of the vehicle 104. The data may be related to the vehicle's performance, such as acceleration, deceleration, gyrometer, seat sensor data, steering data, and the like. The data may be collected and trended over time (e.g., average speed or average acceleration from a stop). The data may be collected and transmitted to a vehicle database 200.

To mitigate privacy issues, one or more mechanisms may be used. First, the driver, the vehicle, or the location may be anonymized. Instead of transferring data that describes a particular vehicle, driver, or location, the data may be generalized or otherwise obscured. For example, instead of transmitting that the driver weighs 214 pounds, the data may be generalized to indicate that the driver is in one of several weight brackets, such as 100-120 pounds, 120-150 pounds, 150-180 pounds, and over 180 pounds. Similarly, instead of transmitting a specific make, model, or year of a vehicle, the vehicle may be generalized into a range of years that have substantially the same design.

Another mechanism that may be used to mitigate privacy issues is to process data locally as much as possible. For example, using an on-board system, the data may be analyzed, summarized, or otherwise processed to produce only statistical results.

Various data may be collected and transferred to the vehicle database 200. Data indicating an aggressive or sporty driving style, such as frequent tight turns, high acceleration, and short time to change lanes, may be collected and transmitted. In addition, other data may be collected and analyzed in order to directly measure or indirectly infer various qualities of how the vehicle is used. A few characteristics and qualities are provided here.

“Sportiness” or “do people drive this car as a sporty car?” An accelerometer/gyrometer may be used to detect tight turns, winding roads, high acceleration, and quick stops, which are indicative of a sporty drive. Global positioning systems (GPS) and road maps may be correlated with car speed to determine how often the car is driven at or near the speed limit. Road maps may be provided by a map database 204. The map database 204 may be incorporated into the on-board system in a vehicle or may be provided by an external service.

On the other end of the spectrum from sportiness, is conservativeness. “Conservative car” or “do people drive this car conservatively?” or “do safety conscious people buy this car?” Accelerometer, gyrometer, steering wheel, brake, and turn signal data may infer slower changes in speed and direction, longer time between the start of the turn signal and the turn itself. With road maps and GPS, length of time at stop lights and stop signs may be measured, as well as the relationship between speed limit and typical speed the car is driven.

“Family car” or “what groups of people are transported in this car.” Seat sensors may be used to determine the number of passengers and their approximate weight, which may identify cars that are frequently used as family cars.

“Shared car” vs. “solo car”. Many car models identify the driver by, for example, the key they use. Other means of identification have been shown feasible by others (e.g., face recognition; weight distribution in seat; settings of seat position, etc.). This information over time may suggest whether multiple people share a car (husband, wife, and driving child) or if the car is mainly one person's car.

“Commuter car” vs. “Day-trip car” vs. “Vacation car”. GPS in the car may be used to determine how frequently the car is used to drive repetitive trips (e.g., between home and work) versus unique, longer trips (e.g., a weekend or week between leaving home and returning, with stops at different places each night).

Actual Mileage. Distribution among instances of a given car model of actual mileage versus EPA estimates. This may be correlated to driving style, to give a car shopper a personalized idea of what mileage they might expect from a given car. For electric vehicles, charging frequency and duration statistics may be similarly compared.

Feature use. How often specific features are used. For example, how often is 4-wheel drive engaged on this SUV? How often does the adaptive cruise control engage? The frequency of use may indicate the feature's value.

Conditions of use. How often is the car driven in snow or rain? How does the car perform in snow or rain? Various safety systems may be used to detect the existence of snow or rain, such as detecting anti-lock brakes slipping in combination with an external temperature, or by determining windshield wiper speed and duration. The car's performance may be measured by detecting skidding and single-wheel slippage, mileage, or other facets of performance in various conditions.

Other types of information may be collected, such as detectable maintenance issues (e.g., low oil level, misfiring cylinders, incorrect air/fuel ratio, etc.), the frequency of near misses versus actual accidents (e.g., using anti-lock brake detection, gyrometer, steering wheel, air bag deployment, etc.), and catastrophic battery failures in hybrid vehicles. Such information may be useful to a potential buyer to evaluate the safety, reliability, or expected maintenance costs of a vehicle.

The vehicle database 200 may be used to drive a web site or other interactive online resource. For example, a user who may be shopping for a new vehicle may access the web site 122 and enter one or more parameters. The parameters may indicate the situation of the user (e.g., size of family, age of driver, preference of vehicle type, etc.) or other information indicating a vehicle or vehicle class the user is interested in (e.g., family car, sports car, import, domestic, compact, full-size, hybrid, etc.). After entering the parameters, the user may submit a query to the vehicle database 200, which may result in one or more vehicles with the objective measurement-based ratings.

Thus, in contrast to other vehicle recommendation or review resources, which are based on professional reviews, manufacturer recommendations, or personal review without actual performance data, the systems described herein may provide an objective review based on actual data that was collected from a vehicle or other vehicle-related sensor.

The web site 122 may include other types of reviews, such as professional or user reviews, alongside or in addition to the objective ratings. The objective ratings may be used to verify the veracity of professional or user reviews. A person who owns a particular vehicle and writes a review of the vehicle may be able to attest that they have actually used the vehicle being reviewed and provide statistics of the vehicle's use. A system with access to the driver's data in the vehicle database 200, may attest that the reviewer has actually used the car being reviewed, optionally attesting that the reviewer has used that model of car in a relevant way (e.g., a person who has driven their family in the given car, commenting on that car's family-friendliness). This may provide confidence in the reviewer; the actual statistics may confirm the veracity of the reviewer's statements. In addition, the reviewer may be tagged as a participant in a program that monitors vehicles for objective reviews.

FIG. 3 is a flowchart illustrating a method 300 for calculating vehicle ratings via measured driver behavior, according to an embodiment. At 302, vehicle operation data for a vehicle is received. In an embodiment, the vehicle operation data comprises a vehicle performance metric or an environmental metric. In a further embodiment, the vehicle performance metric comprises a vehicle speed, fuel efficiency, an acceleration, or a deceleration. In another further embodiment, the environmental metric comprises a number of occupants in the vehicle, a condition of the road that the vehicle has travelled over, an outside temperature, a weather metric that the vehicle was operated in, or a route that the vehicle was driven.

In an embodiment, receiving vehicle operation data for the vehicle comprises receiving the vehicle operation data directly from the vehicle.

In an embodiment, receiving vehicle operation data for the vehicle comprises receiving the vehicle operation data from a user device, which obtained the vehicle operation data when communicatively connected to the vehicle.

In various embodiments, the vehicle is one of a car, a truck, or a motorcycle.

At 304, using the vehicle operation data, data describing how the vehicle was used is determined. This may be performed in various ways.

In an embodiment, determining data describing how the vehicle was used comprises evaluating the vehicle operation data to determine an acceleration/deceleration pattern and rating the acceleration/deceleration pattern on a conservative-sportiness driving continuum. In an embodiment, determining data describing how the vehicle was used comprises evaluating the vehicle operation data to determine a turning pattern and rating the turning pattern on a conservative-sportiness driving continuum.

In an embodiment, determining data describing how the vehicle was used comprises evaluating the vehicle operation data to determine a fuel efficiency pattern and rating the fuel efficiency pattern in view of a generally accepted estimated fuel efficiency.

In an embodiment, determining data describing how the vehicle was used comprises evaluating the vehicle operation data to determine an occupant pattern and rating the occupant pattern on a family car use continuum.

In an embodiment, determining data describing how the vehicle was used comprises evaluating the vehicle operation data to determine an occupant pattern and rating the occupant pattern on a shared vehicle continuum.

In an embodiment, determining data describing how the vehicle was used comprises evaluating the vehicle operation data to determine a usage route pattern and rating the usage route pattern on a commuter-vacation use continuum.

In an embodiment, determining data describing how the vehicle was used comprises evaluating the vehicle operation data to determine a usage pattern for one of a weather or road condition that describes a driving situation and rating the usage pattern for the driving situation.

At 306, a vehicle database is searched to identify vehicles similar to the vehicle. In an embodiment, searching the vehicle database to identify vehicles similar to the vehicle comprises identifying at least one of a make, a model, or a year of the vehicle and searching the vehicle database to identify vehicles similar to the vehicle based on at least one of the make, the model, or the year of the vehicle.

In an embodiment, searching the vehicle database to identify vehicles similar to the vehicle comprises identifying how the vehicle was used and searching the vehicle database to identify vehicles similar to the vehicle based on how the vehicle was used.

At 308, the data describing how the vehicle was used is aggregated with data describing how vehicles similar to the vehicle were used, to produce aggregated data.

At 310, a result based on the aggregated data is calculated.

In an embodiment, calculating the result based on the aggregated data comprises identifying a typical use of the vehicle based on the aggregated data and representing the result as an indication of the typical use. In a further embodiment, the indication of the typical use comprises a percentage indicating the amount of time the vehicle was used in accordance with the typical use. In another further embodiment, the indication of the typical use comprises a percentage indicating the amount of distance the vehicle was used in accordance with the typical use. In an embodiment, the amount of distance comprises one of a miles or a kilometers.

The method 300 may further comprise receiving from a user, an identification of a driver, determining characteristics of the driver, matching the driver with a recommended vehicle by comparing the characteristics of the driver with the result based on the aggregated data, and providing the recommended vehicle to the user.

The method 300 may further comprise receiving from a user, an intended use of vehicle, searching the vehicle database to identify a recommended vehicle that corresponds with the intended use of the vehicle, and providing the recommended vehicle to the user.

The method 300 may further comprise providing a statistical breakdown describing how the recommended vehicle was used.

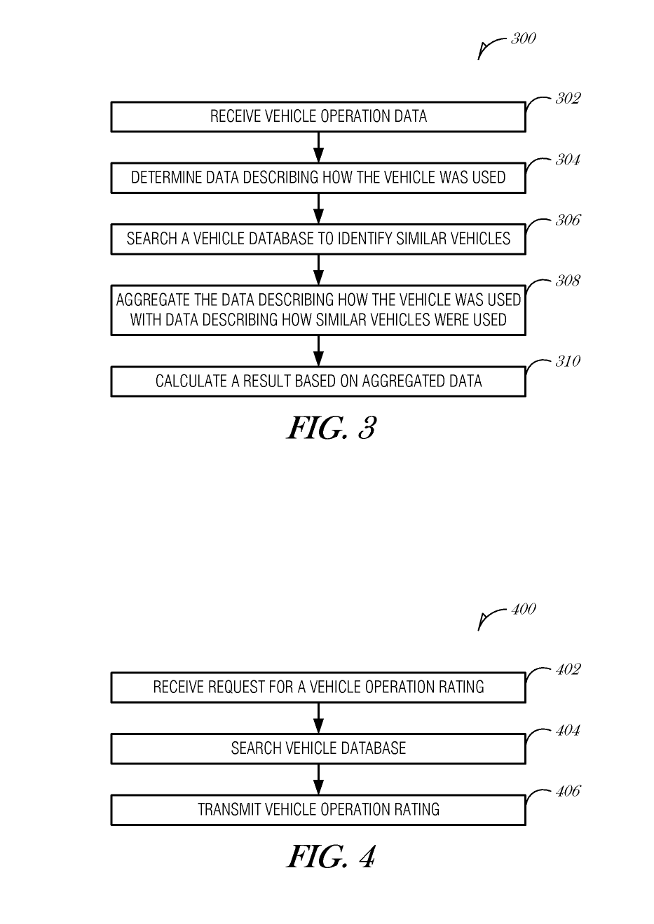

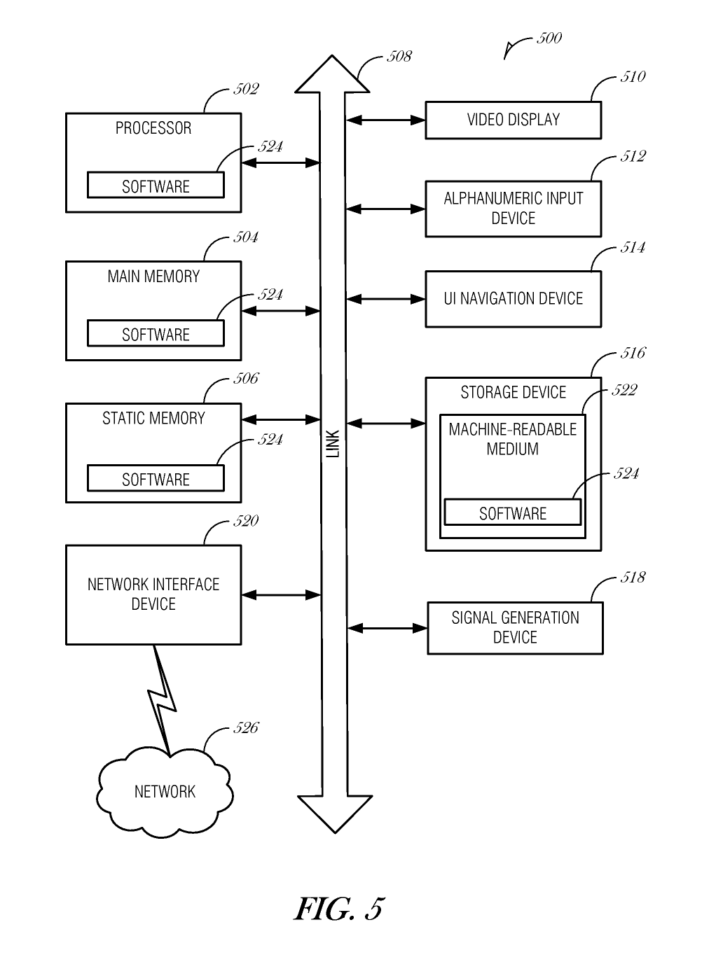

FIG. 4 is a flowchart illustrating a method 400 for providing vehicle ratings, according to an embodiment. At 402, a request for a vehicle operation rating of a vehicle is received at a computing device from a user device. In an embodiment, the vehicle operation data is obtained from a plurality of respective vehicles, via an on-board system in the plurality of respective vehicles. In an embodiment, the vehicle operation data comprises a vehicle performance metric or an environmental metric. In an embodiment, the vehicle performance metric comprises a vehicle speed, fuel efficiency, an acceleration, or a deceleration. In an embodiment, the environmental metric comprises a number of occupants in the vehicle, a condition of the road that the vehicle has travelled over, an outside temperature, a weather metric that the vehicle was operated in, or a route that the vehicle was driven. In an embodiment, the vehicle operation data is obtained directly from the plurality of respective vehicles.

At 404, a vehicle database is searched for the vehicle operation rating of the vehicle, the vehicle operation data comprising data from a plurality of vehicles similar to the vehicle, the data describing aspects of vehicle operation used to calculate the vehicle operation rating.

At 406, the vehicle operation rating of the vehicle is transmitted to user device. The user device may be a mobile device (e.g., mobile device 106 of FIG. 1).

Embodiments may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

Examples, as described herein, may include, or may operate on, logic or a number of components, modules, or mechanisms. Modules may be hardware, software, or firmware communicatively coupled to one or more processors in order to carry out the operations described herein. Modules may hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

FIG. 5 is a block diagram illustrating a machine in the example form of a computer system 500, within which a set or sequence of instructions may be executed to cause the machine to perform any one of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be an onboard vehicle system, wearable device, personal computer (PC), a tablet PC, a hybrid tablet, a personal digital assistant (PDA), a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 500 includes at least one processor 502 (e.g., a central processing unit (CPU), a graphics processing unit (GPU) or both, processor cores, compute nodes, etc.), a main memory 504 and a static memory 506, which communicate with each other via a link 508 (e.g., bus). The computer system 500 may further include a video display unit 510, an alphanumeric input device 512 (e.g., a keyboard), and a user interface (UI) navigation device 514 (e.g., a mouse). In one embodiment, the video display unit 510, input device 512 and UI navigation device 514 are incorporated into a touch screen display. The computer system 500 may additionally include a storage device 516 (e.g., a drive unit), a signal generation device 518 (e.g., a speaker), a network interface device 520, and one or more sensors (not shown), such as a global positioning system (GPS) sensor, compass, accelerometer, or other sensor.

The storage device 516 includes a machine-readable medium 522 on which is stored one or more sets of data structures and instructions 524 (e.g., software) embodying or utilized by any one or more of the methodologies or functions described herein. The instructions 524 may also reside, completely or at least partially, within the main memory 504, static memory 506, and/or within the processor 502 during execution thereof by the computer system 500, with the main memory 504, static memory 506, and the processor 502 also constituting machine-readable media.

While the machine-readable medium 522 is illustrated in an example embodiment to be a single medium, the term “machine-readable medium” may include a single medium or multiple media (e.g., a centralized or distributed database, and/or associated caches and servers) that store the one or more instructions 524. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 524 may further be transmitted or received over a communications network 526 using a transmission medium via the network interface device 520 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi, 3G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

### Additional Notes & Examples

Example 1 includes subject matter (such as a device, apparatus, or machine) comprising a system to provide vehicle ratings via measured driver behavior, comprising a receiving module to receive vehicle operation data for a vehicle; a determination module to use the vehicle operation data to determine data describing how the vehicle was used; a search module to search a vehicle database to identify vehicles similar to the vehicle; an aggregation module to aggregate the data describing how the vehicle was used with data describing how vehicles similar to the vehicle were used, to produce aggregated data; and a calculation module to calculate a result based on the aggregated data.

In Example 2, the subject matter of Example 1 may optionally include, wherein the vehicle operation data comprises a vehicle performance metric or an environmental metric.

In Example 3, the subject matter of any one or more of Examples 1 to 2 may optionally include, wherein the vehicle performance metric comprises a vehicle speed, fuel efficiency, an acceleration, or a deceleration.

In Example 4, the subject matter of any one or more of Examples 1 to 3 may optionally include, wherein the environmental metric comprises a number of occupants in the vehicle, a condition of the road that the vehicle has travelled over, an outside temperature, a weather metric that the vehicle was operated in, or a route that the vehicle was driven.

In Example 5, the subject matter of any one or more of Examples 1 to 4 may optionally include, wherein to receive vehicle operation data for the vehicle, the receiving module is to receive the vehicle operation data directly from the vehicle.

In Example 6, the subject matter of any one or more of Examples 1 to 5 may optionally include, wherein to receive vehicle operation data for the vehicle, the receiving module is to receive the vehicle operation data from a user device, which obtained the vehicle operation data when communicatively connected to the vehicle.

In Example 7, the subject matter of any one or more of Examples 1 to 6 may optionally include, wherein the vehicle is one of a car, a truck, or a motorcycle.

In Example 8, the subject matter of any one or more of Examples 1 to 7 may optionally include, wherein to determine data describing how the vehicle was used, the determination module is to: evaluate the vehicle operation data to determine an acceleration/deceleration pattern; and rate the acceleration/deceleration pattern on a conservative-sportiness driving continuum.

In Example 9, the subject matter of any one or more of Examples 1 to 8 may optionally include, wherein to determine data describing how the vehicle was used, the determination module is to: evaluate the vehicle operation data to determine a turning pattern; and rate the turning pattern on a conservative-sportiness driving continuum.

In Example 10, the subject matter of any one or more of Examples 1 to 9 may optionally include, wherein to determine data describing how the vehicle was used, the determination module is to: evaluate the vehicle operation data to determine a fuel efficiency pattern; and rate the fuel efficiency pattern in view of a generally accepted estimated fuel efficiency.

In Example 11, the subject matter of any one or more of Examples 1 to 10 may optionally include, wherein to determine data describing how the vehicle was used, the determination module is to: evaluate the vehicle operation data to determine an occupant pattern; and rate the occupant pattern on a family car use continuum.

In Example 12, the subject matter of any one or more of Examples 1 to 11 may optionally include, wherein to determine data describing how the vehicle was used, the determination module is to: evaluate the vehicle operation data to determine an occupant pattern; and rate the occupant pattern on a shared vehicle continuum.

In Example 13, the subject matter of any one or more of Examples 1 to 12 may optionally include, wherein to determine data describing how the vehicle was used, the determination module is to: evaluate the vehicle operation data to determine a usage route pattern; and rate the usage route pattern on a commuter-vacation use continuum.

In Example 14, the subject matter of any one or more of Examples 1 to 13 may optionally include, wherein to determine data describing how the vehicle was used, the determination module is to: evaluate the vehicle operation data to determine a usage pattern for one of a weather or road condition that describes a driving situation; and rate the usage pattern for the driving situation.

In Example 15, the subject matter of any one or more of Examples 1 to 14 may optionally include, wherein to search the vehicle database to identify vehicles similar to the vehicle, the search module is to: identify at least one of a make, a model, or a year of the vehicle; and search the vehicle database to identify vehicles similar to the vehicle based on at least one of the make, the model, or the year of the vehicle.

In Example 16, the subject matter of any one or more of Examples 1 to 15 may optionally include, wherein to search the vehicle database to identify vehicles similar to the vehicle, the search module is to: identify how the vehicle was used; and search the vehicle database to identify vehicles similar to the vehicle based on how the vehicle was used.

In Example 17, the subject matter of any one or more of Examples 1 to 16 may optionally include, wherein to calculate the result based on the aggregated data, the calculation module is to: identify a typical use of the vehicle based on the aggregated data; and represent the result as an indication of the typical use.

In Example 18, the subject matter of any one or more of Examples 1 to 17 may optionally include, wherein the indication of the typical use comprises a percentage indicating the amount of time the vehicle was used in accordance with the typical use.

In Example 19, the subject matter of any one or more of Examples 1 to 18 may optionally include, wherein the indication of the typical use comprises a percentage indicating the amount of distance the vehicle was used in accordance with the typical use.

In Example 20, the subject matter of any one or more of Examples 1 to 19 may optionally include, wherein the amount of distance comprises one of a miles or a kilometers.

In Example 21, the subject matter of any one or more of Examples 1 to 20 may optionally include, a user module to: receive from a user, an identification of a driver; determine characteristics of the driver; match the driver with a recommended vehicle by comparing the characteristics of the driver with the result based on the aggregated data; and provide the recommended vehicle to the user.

In Example 22, the subject matter of any one or more of Examples 1 to 21 may optionally include, a user module to: receive from a user, an intended use of vehicle; search the vehicle database to identify a recommended vehicle that corresponds with the intended use of the vehicle; and provide the recommended vehicle to the user.

In Example 23, the subject matter of any one or more of Examples 1 to 22 may optionally include, wherein the user module is to provide a statistical breakdown describing how the recommended vehicle was used.

Example 24 includes subject matter for calculating vehicle ratings via measured driver behavior (such as a method, means for performing acts, machine readable medium including instructions that when performed by a machine cause the machine to performs acts, or an apparatus configured to perform) comprising: receiving vehicle operation data for a vehicle; using the vehicle operation data, determining data describing how the vehicle was used; searching a vehicle database to identify vehicles similar to the vehicle; aggregating the data describing how the vehicle was used with data describing how vehicles similar to the vehicle were used, to produce aggregated data; and calculating a result based on the aggregated data.

In Example 25, the subject matter of Example 24 may optionally include, wherein the vehicle operation data comprises a vehicle performance metric or an environmental metric.

In Example 26, the subject matter of any one or more of Examples 24 to 25 may optionally include, wherein the vehicle performance metric comprises a vehicle speed, fuel efficiency, an acceleration, or a deceleration.

In Example 27, the subject matter of any one or more of Examples 24 to 26 may optionally include, wherein the environmental metric comprises a number of occupants in the vehicle, a condition of the road that the vehicle has travelled over, an outside temperature, a weather metric that the vehicle was operated in, or a route that the vehicle was driven.

In Example 28, the subject matter of any one or more of Examples 24 to 27 may optionally include, wherein receiving vehicle operation data for the vehicle comprises receiving the vehicle operation data directly from the vehicle.

In Example 29, the subject matter of any one or more of Examples 24 to 28 may optionally include, wherein receiving vehicle operation data for the vehicle comprises receiving the vehicle operation data from a user device, which obtained the vehicle operation data when communicatively connected to the vehicle.

In Example 30, the subject matter of any one or more of Examples 24 to 29 may optionally include, wherein the vehicle is one of a car, a truck, or a motorcycle.

In Example 31, the subject matter of any one or more of Examples 24 to 30 may optionally include, wherein determining data describing how the vehicle was used comprises: evaluating the vehicle operation data to determine an acceleration/deceleration pattern; and rating the acceleration/deceleration pattern on a conservative-sportiness driving continuum.

In Example 32, the subject matter of any one or more of Examples 24 to 31 may optionally include, wherein determining data describing how the vehicle was used comprises: evaluating the vehicle operation data to determine a turning pattern; and rating the turning pattern on a conservative-sportiness driving continuum.

In Example 33, the subject matter of any one or more of Examples 24 to 32 may optionally include, wherein determining data describing how the vehicle was used comprises: evaluating the vehicle operation data to determine a fuel efficiency pattern; and rating the fuel efficiency pattern in view of a generally accepted estimated fuel efficiency.

In Example 34, the subject matter of any one or more of Examples 24 to 33 may optionally include, wherein determining data describing how the vehicle was used comprises: evaluating the vehicle operation data to determine an occupant pattern; and rating the occupant pattern on a family car use continuum.

In Example 35, the subject matter of any one or more of Examples 24 to 34 may optionally include, wherein determining data describing how the vehicle was used comprises: evaluating the vehicle operation data to determine an occupant pattern; and rating the occupant pattern on a shared vehicle continuum.

In Example 36, the subject matter of any one or more of Examples 24 to 35 may optionally include, wherein determining data describing how the vehicle was used comprises: evaluating the vehicle operation data to determine a usage route pattern; and rating the usage route pattern on a commuter-vacation use continuum.

In Example 37, the subject matter of any one or more of Examples 24 to 36 may optionally include, wherein determining data describing how the vehicle was used comprises: evaluating the vehicle operation data to determine a usage pattern for one of a weather or road condition that describes a driving situation; and rating the usage pattern for the driving situation.

In Example 38, the subject matter of any one or more of Examples 24 to 37 may optionally include, wherein searching the vehicle database to identify vehicles similar to the vehicle comprises: identifying at least one of a make, a model, or a year of the vehicle; and searching the vehicle database to identify vehicles similar to the vehicle based on at least one of the make, the model, or the year of the vehicle.

In Example 39, the subject matter of any one or more of Examples 24 to 38 may optionally include, wherein searching the vehicle database to identify vehicles similar to the vehicle comprises: identifying how the vehicle was used; and searching the vehicle database to identify vehicles similar to the vehicle based on how the vehicle was used.

In Example 40, the subject matter of any one or more of Examples 24 to 39 may optionally include, wherein calculating the result based on the aggregated data comprises: identifying a typical use of the vehicle based on the aggregated data; and representing the result as an indication of the typical use.

In Example 41, the subject matter of any one or more of Examples 24 to 40 may optionally include, wherein the indication of the typical use comprises a percentage indicating the amount of time the vehicle was used in accordance with the typical use.

In Example 42, the subject matter of any one or more of Examples 24 to 41 may optionally include, wherein the indication of the typical use comprises a percentage indicating the amount of distance the vehicle was used in accordance with the typical use.

In Example 43, the subject matter of any one or more of Examples 24 to 42 may optionally include, wherein the amount of distance comprises one of a miles or a kilometers.

In Example 44, the subject matter of any one or more of Examples 24 to 43 may optionally include, receiving from a user, an identification of a driver; determining characteristics of the driver; matching the driver with a recommended vehicle by comparing the characteristics of the driver with the result based on the aggregated data; and providing the recommended vehicle to the user.

In Example 45, the subject matter of any one or more of Examples 24 to 44 may optionally include, receiving from a user, an intended use of vehicle; searching the vehicle database to identify a recommended vehicle that corresponds with the intended use of the vehicle; and providing the recommended vehicle to the user.

In Example 46, the subject matter of any one or more of Examples 24 to 45 may optionally include, providing a statistical breakdown describing how the recommended vehicle was used.

Example 47 includes an apparatus to calculate vehicle ratings via measured driver behavior, the apparatus comprising: means for receiving vehicle operation data for a vehicle; means for using the vehicle operation data, determining data describing how the vehicle was used; means for searching a vehicle database to identify vehicles similar to the vehicle; means for aggregating the data describing how the vehicle was used with data describing how vehicles similar to the vehicle were used, to produce aggregated data; and means for calculating a result based on the aggregated data.

Example 48 includes subject matter (such as a device, apparatus, or machine) comprising a system to provide vehicle ratings via measured driver behavior, comprising a receiving module to receive, from a user device, a request for a vehicle operation rating of a vehicle; a search module to search a vehicle database for the vehicle operation rating of the vehicle, the vehicle operation data comprising data from a plurality of vehicles similar to the vehicle, the data describing aspects of vehicle operation used to calculate the vehicle operation rating; and a transceiver to transmit the vehicle operation rating of the vehicle to user device.

In Example 49, the subject matter of Example 48 may optionally include, wherein the vehicle operation data is obtained from a plurality of respective vehicles, via an on-board system in the plurality of respective vehicles.

In Example 50, the subject matter of any one or more of Examples 48 to 49 may optionally include, wherein the vehicle operation data comprises a vehicle performance metric or an environmental metric.

In Example 51, the subject matter of any one or more of Examples 48 to 50 may optionally include, wherein the vehicle performance metric comprises a vehicle speed, fuel efficiency, an acceleration, or a deceleration.

In Example 52, the subject matter of any one or more of Examples 48 to 51 may optionally include, wherein the environmental metric comprises a number of occupants in the vehicle, a condition of the road that the vehicle has travelled over, an outside temperature, a weather metric that the vehicle was operated in, or a route that the vehicle was driven.

In Example 53, the subject matter of any one or more of Examples 48 to 52 may optionally include, wherein the vehicle operation data is obtained directly from the plurality of respective vehicles.

Example 54 includes subject matter for providing vehicle ratings (such as a method, means for performing acts, machine readable medium including instructions that when performed by a machine cause the machine to performs acts, or an apparatus configured to perform) comprising receiving at a computing device from a user device, a request for a vehicle operation rating of a vehicle; searching a vehicle database for the vehicle operation rating of the vehicle, the vehicle operation data comprising data from a plurality of vehicles similar to the vehicle, the data describing aspects of vehicle operation used to calculate the vehicle operation rating; and transmitting the vehicle operation rating of the vehicle to user device.

In Example 55, the subject matter of Example 54 may optionally include, wherein the vehicle operation data is obtained from a plurality of respective vehicles, via an on-board system in the plurality of respective vehicles.

In Example 56, the subject matter of any one or more of Examples 54 to 55 may optionally include, wherein the vehicle operation data comprises a vehicle performance metric or an environmental metric.

In Example 57, the subject matter of any one or more of Examples 54 to 56 may optionally include, wherein the vehicle performance metric comprises a vehicle speed, fuel efficiency, an acceleration, or a deceleration.

In Example 58, the subject matter of any one or more of Examples 54 to 57 may optionally include, wherein the environmental metric comprises a number of occupants in the vehicle, a condition of the road that the vehicle has travelled over, an outside temperature, a weather metric that the vehicle was operated in, or a route that the vehicle was driven.

In Example 59, the subject matter of any one or more of Examples 54 to 58 may optionally include, wherein the vehicle operation data is obtained directly from the plurality of respective vehicles.

Example 60 includes a machine-readable medium including instructions for providing vehicle ratings, which when executed by a machine, cause the machine to perform operations of any one of the Examples 1-59.

Example 61 includes an apparatus comprising means for performing any of the Examples 47-59.

Example 62 includes an apparatus comprising means for receiving at a computing device from a user device, a request for a vehicle operation rating of a vehicle; means for searching a vehicle database for the vehicle operation rating of the vehicle, the vehicle operation data comprising data from a plurality of vehicles similar to the vehicle, the data describing aspects of vehicle operation used to calculate the vehicle operation rating; and means for transmitting the vehicle operation rating of the vehicle to user device.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure, for example, to comply with 37 C.F.R. §1.72(b) in the United States of America. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

1.-25. (canceled)

26. A machine-readable medium including instructions for calculating vehicle ratings via measured driver behavior, which when executed by a machine, cause the machine to:
receive vehicle operation data for a vehicle;
use the vehicle operation data, determining data describing how the vehicle was used;
search a vehicle database to identify vehicles similar to the vehicle;
aggregate the data describing how the vehicle was used with data describing how vehicles similar to the vehicle were used, to produce aggregated data; and
calculate a result based on the aggregated data.

27. The machine-readable medium of claim 26, wherein the vehicle operation data comprises a vehicle performance metric or an environmental metric.

28. The machine-readable medium of claim 27, wherein the vehicle performance metric comprises a vehicle speed, fuel efficiency, an acceleration, or a deceleration.

29. The machine-readable medium of claim 27, wherein the environmental metric comprises a number of occupants in the vehicle, a condition of the road that the vehicle has travelled over, an outside temperature, a weather metric that the vehicle was operated in, or a route that the vehicle was driven.

30. The machine-readable medium of claim 26, wherein the instructions to receive vehicle operation data for the vehicle comprise instructions to receive the vehicle operation data directly from the vehicle.

31. The machine-readable medium of claim 26, wherein the instructions to receive vehicle operation data for the vehicle comprise instructions to receive the vehicle operation data from a user device, which obtained the vehicle operation data when communicatively connected to the vehicle.

32. The machine-readable medium of claim 26, wherein the vehicle is one of a car, a truck, or a motorcycle.

33. The machine-readable medium of claim 26, wherein the instructions to determine data describing how the vehicle was used comprise instructions to:
evaluate the vehicle operation data to determine an acceleration/deceleration pattern; and
rate the acceleration/deceleration pattern on a conservative-sportiness driving continuum.

34. The machine-readable medium of claim 26, wherein the instructions to determine data describing how the vehicle was used comprise instructions to:
evaluate the vehicle operation data to determine a turning pattern; and
rate the turning pattern on a conservative-sportiness driving continuum.

35. The machine-readable medium of claim 26, wherein the instructions to determine data describing how the vehicle was used comprise instructions to:
evaluate the vehicle operation data to determine a fuel efficiency pattern; and
rate the fuel efficiency pattern in view of a generally accepted estimated fuel efficiency.

36. The machine-readable medium of claim 26, wherein the instructions to determining data describing how the vehicle was used comprise instructions to:
evaluate the vehicle operation data to determine an occupant pattern; and
rate the occupant pattern on a family car use continuum.

37. The machine-readable medium of claim 26, wherein the instructions to determining data describing how the vehicle was used comprise instructions to:
evaluate the vehicle operation data to determine an occupant pattern; and
rate the occupant pattern on a shared vehicle continuum.

38. The machine-readable medium of claim 26, wherein the instructions to determining data describing how the vehicle was used comprise instructions to:
evaluate the vehicle operation data to determine a usage route pattern; and
rate the usage route pattern on a commuter-vacation use continuum.

39. The machine-readable medium of claim 26, wherein the instructions to searching the vehicle database to identify vehicles similar to the vehicle comprise instructions to:
identify at least one of a make, a model, or a year of the vehicle; and
search the vehicle database to identify vehicles similar to the vehicle based on at least one of the make, the model, or the year of the vehicle.

40. The machine-readable medium of claim 26, wherein the instructions to searching the vehicle database to identify vehicles similar to the vehicle comprise instructions to:
identify how the vehicle was used; and
search the vehicle database to identify vehicles similar to the vehicle based on how the vehicle was used.

41. The machine-readable medium of claim 26, wherein the instructions to calculate the result based on the aggregated data comprise instructions to:
identify a typical use of the vehicle based on the aggregated data; and
represent the result as an indication of the typical use.

42. A system to calculate vehicle ratings via measured driver behavior, the system comprising:
a receiving module to receive vehicle operation data for a vehicle;
a determination module to use the vehicle operation data to determine data describing how the vehicle was used;
a search module to search a vehicle database to identify vehicles similar to the vehicle;
an aggregation module to aggregate the data describing how the vehicle was used with data describing how vehicles similar to the vehicle were used, to produce aggregated data; and
a calculation module to calculate a result based on the aggregated data.

43. The system of claim 42, further comprising a user module to:
receive from a user, an identification of a driver;
determine characteristics of the driver;
match the driver with a recommended vehicle by comparing the characteristics of the driver with the result based on the aggregated data; and
provide the recommended vehicle to the user.

44. A method for calculating vehicle ratings via measured driver behavior, the method comprising:
receiving vehicle operation data for a vehicle;
using the vehicle operation data, determining data describing how the vehicle was used;
searching a vehicle database to identify vehicles similar to the vehicle;
aggregating the data describing how the vehicle was used with data describing how vehicles similar to the vehicle were used, to produce aggregated data; and
calculating a result based on the aggregated data.

45. The method of claim 44, wherein searching the vehicle database to identify vehicles similar to the vehicle comprises:
identifying how the vehicle was used; and
searching the vehicle database to identify vehicles similar to the vehicle based on how the vehicle was used.
